(19) United States
(12) Patent Application Publication
(10) Pub. No.: US 2015/0100236 A1
(43) Pub. Date: Apr. 9, 2015

(54) NAVIGATION SYSTEM

(71) Applicant: Ronen HARTMAN, Haifa (IL)

(72) Inventor: Ronen HARTMAN, Haifa (IL)

(21) Appl. No.: 14/493,404

(22) Filed: Sep. 23, 2014

Related U.S. Application Data
(60) Provisional application No. 61/888,515, filed on Oct. 9, 2013.
(60) Provisional application No. 61/908,856, filed on Nov. 26, 2013.

(51) Int. Cl. G01C 21/20

(52) U.S. Cl. CPC G01C 21/20
USPC 701/522

(57) ABSTRACT

A navigation system for enabling a user to navigate via his computerized device without having to insert the address of the destination is disclosed herein. Such a system may be used by tourists, for example, who have difficulties to insert the details of the destination. Such a navigation system address enables the tourists to specify the destination address by activating a gadget (such as a button, for example) on the web site.

### FIELD OF THE INVENTION

The present disclosure relates to navigation in general, and to navigation via the internet, in particular.

### BACKGROUND OF THE INVENTION

Navigation applications are used for navigating a person from the current location to the destination. A typical navigation application provides vocal or written instructions and may also provide a map with the route from the current location to the destination. The navigation is typically based on GPS. (Global Positioning System). Examples of such navigation systems are Waze and Google maps.

### SUMMARY OF THE INVENTION

A navigation system for enabling a user to navigate via his computerized device without having to insert the address of the destination is disclosed herein. Such a system may be used by tourists, for example, who have difficulties to insert the details of the destination. Such a navigation system address enables the tourists to specify the destination address by activating a gadget (such as a button, for example) on the web site.

According to some embodiments a web site associated with a geographical site may include a gadget such as a button that, when being activated, sends the coordinates of the geographical site to an application of a computerized device which will activate a navigation application according to the coordinates that were sent. In some embodiments the navigation application is a proprietary application. In some other embodiments the navigation application is a generic application. Such a generic application may be, for example Waze or Google maps.

According to some embodiments, the list of the sites that support the navigation system is provided via the web. A user may access the list via the internet and may access the web page that he is interested in via the list and may click on the navigation button of the desired web page in order to navigate to the desired destination.

One exemplary embodiment of the disclosed subject matter is a navigation system; the system comprising: a data repository being configured for storing location data of a geographical site; a server configured for receiving, from a computerized device, a request for navigating to said geographical site; said request being received as a result of activating a gadget on a web site; said web site being associated with said geographical site; wherein said server is farther configured for retrieving said location data from said data repository and for returning said location data to said computerized device; and a location module; said location module being activated by said computerized device; said location module being configured for receiving said location data from said server and for utilizing said location data for activating a navigation application; thereby enabling a user of said web site to navigate to said physical site without inserting the address of said physical site.

According to some embodiments the geographical site being one member of a group consisting of a hotel, a resort, a restaurant, a pub, a church, a touristic site, a government building, an enterprise and a park.

According to some embodiments the navigation application being a generic navigation application. According to some embodiments the navigation application being a proprietary navigation application.

According to some embodiments the computerized device being one member of a group consisting of a laptop, a smart phone, a tablet and a personal computer. According to some embodiments the data repository is farther configured for storing a page of said web site.

One other exemplary embodiment of the disclosed subject matter is a navigation method , said method comprising: receiving location data of a geographical site; said location data being received as a result of activating a gadget in a web site; said web site being associated with said geographical site; and utilizing said location data for activating a navigation application; thereby enabling a user of said web site to navigate to said physical site without typing the address of said physical site.

According to some embodiments the navigation application being a generic navigation application. According to some embodiments he navigation application being a proprietary navigation application. According to some embodiments the geographical site being one member of a group consisting of a hotel, a resort, a restaurant, a pub, a church, a touristic site, a government building, an enterprise and a park.

One other exemplary embodiment of the disclosed subject matter is a computer program placed on a magnetic readable medium, the computer program comprising: a first program instruction for receiving location data of a geographical site from a server; said location data being received as a result of activating a gadget in a web site; said web site being associated with said geographical site ; and a second program instruction for utilizing said location data for activating a navigation application; thereby enabling a user of said web site to navigate to said physical site without typing the address of said physical site.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an exemplary block diagram of a navigation system, in accordance with some exemplary embodiments of the subject matter;

FIG. 2 shows an exemplary flowchart diagram of a method for navigation, in accordance with some exemplary embodiments of the disclosed subject matter; and

FIGS. 3A and 3B show an exemplary flowchart diagram of a scenario for navigation, in accordance with some exemplary embodiments of the disclosed subject matter.

### DETAILED DESCRIPTION

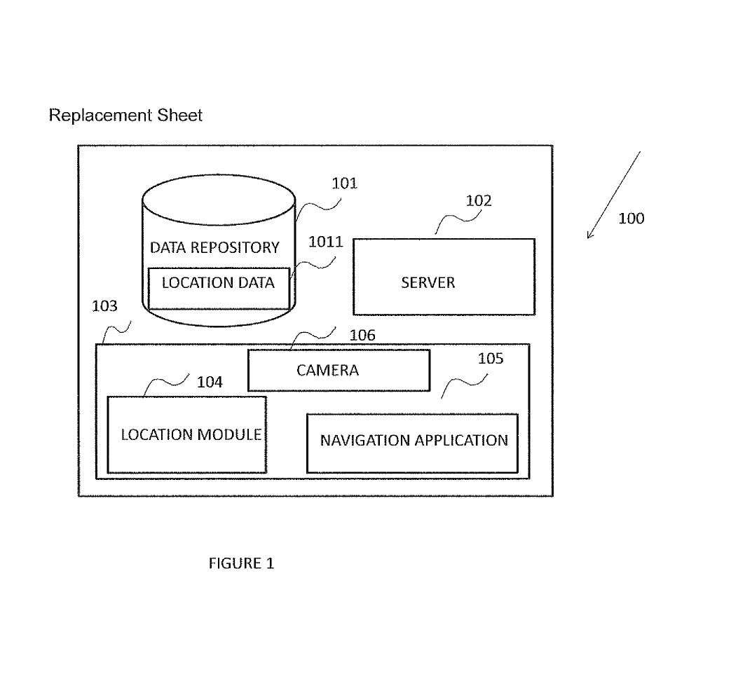

FIG. 1 shows an exemplary block diagram of a navigation system, in accordance with some exemplary embodiments of the subject matter. System 100 may include a data repository 101, a server 102 and a plurality of computerized devices.

The data repository 101 is configured for storing location data of a geographical site 1011. The geographical site may be, for example, a hotel, a resort, a restaurant, a pub, a church, a touristic site, a government building, an enterprise and a park. In some embodiments the data repository 101 is also configured for storing pages of a web site associated with the geographical site. Examples of such web sites are a web site of a hotel, a web site of a ski resort, a web site of a football stadium and the like.

The server 102 is configured for receiving, from a plurality of computerized device 103, a request for navigating to the geographical site. Examples of such computerized devices are a personal computer, a laptop and a Smartphone. The request is received as a result of activating a gadget on a web site. In some cases the gadget is a button which may be activated by hovering or by touching. The server 102 is farther configured for retrieving location data from the data repository 101 and for returning the location data to the computerized device. Alternatively, in some embodiments the location data of a geographical site 1011 is embedded as a code in the pages of the site and is sent directly from the web site. In some cases the server 102 is configured for receiving a captured image that includes the address of the site and for transforming the address that is captured in the image to digital data. The transforming may use image to text techniques.

The computerized device 103 includes a location module 104 and may also include a navigation application 105 and a camera 106. The location module 104 is activated by the computerized device 103. The location module 104 is configured for receiving the location data and for utilizing the location data for activating a navigation application 105 such that the user who surfs the web site does not need to enter the address of the geographical location in order to navigate to the geographical site. In some cases the navigation application 105 is a proprietary application. In some other cases the navigation application 105 is a generic application. The camera 106 is configured to capture an image of the address (for example by capturing a street sign displaying the image). Examples of such generic applications are Waze and Google maps.

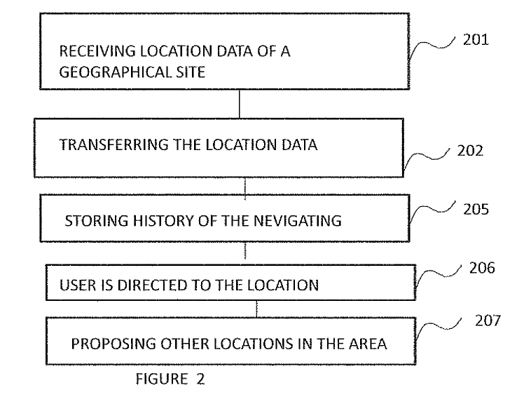

FIG. 2 shows an exemplary flowchart diagram of a method for navigation, in accordance with some exemplary embodiments of the disclosed subject matter.

According to some embodiments a location module is in installed and is activated by a computerized device. The location module is activated as a result of receiving location data. In some embodiments the location data is received from a server. The navigation data may include GPS (global positioning system) parameters. The location module transfers the location data to a navigation module for providing navigation to the location that is identified by the navigation data. In some embodiments the location module also stores history about the navigation request in order to enable the user to view and utilize the history data. In some embodiments the navigation application provides also information about other locations or attractions in the area of the location to which the user whishes to arrive; Referring now to the drawing.

At 201, a location data of a geographic site is received from a server. The geographic site may be, for example, a hotel. The location data is received as a result of activating a gadget in a web site that represents the geographical site. In some cases the location is received from a module that transformed an image of the address that is received from the computerized device of the user. The transformation process utilizes image processing and image recognition techniques.

At 202 the location data is transferred to a navigation application and the navigation application is activated. In some cases the navigation application is a proprietary application. In some other cases the navigation application is a generic application such as “Waze”.

At 205 the details about the navigation request is saved in the history file. Such history data may be utilized by the user in the future.

At 206, the user is directed by the navigation module. The directions may include path to the destination displayed on a map, vocal and textual instructions.

At 207 other attractions in the area are proposed to the user. The proposal may be included in an advertisement.

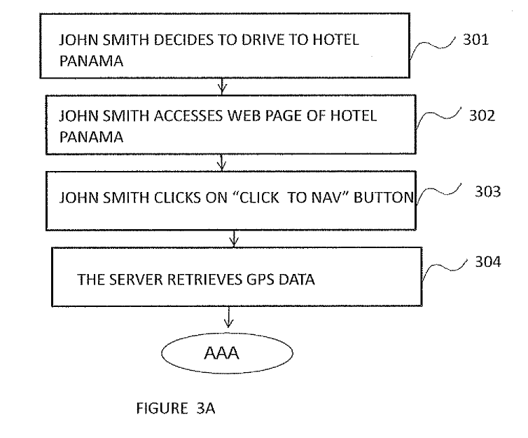

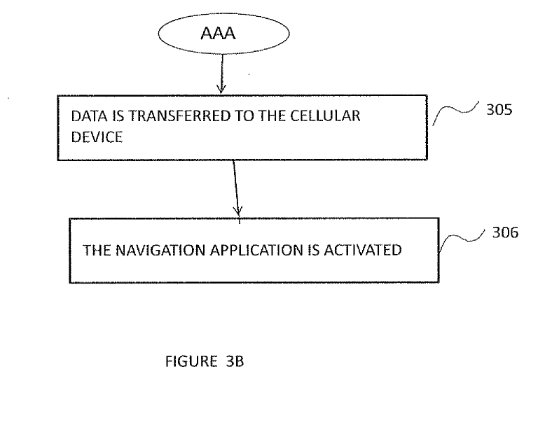

FIGS. 3A and 3B show an exemplary flowchart diagram of a scenario for navigation, in accordance with some exemplary embodiments of the disclosed subject matter.

At 301 John Smith decides to drive to hotel panama.

At 302 John Smith accesses the web page of hotel Panama from his cellular device.

At 303 John Smith clicks on “click to NAV” button on the web page.

At 304 the server retrieves the GPS data of the hotel from the data repository.

At 305 the data is transferred to the cellular devices of John Smith.

At 306 the navigation application is activated on the cellular device. John is directed by the navigation application to hotel Panama. The application displays to John other attractions on the way.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like. Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A navigation system; the system comprising:
a server configured for receiving, from a computerized device, a request for navigating to a geographical site; said request being received as a result of activating a gadget on a web site; said web site being associated with said geographical site; wherein said server is farther configured for providing location data of said geographical site and for returning said location data to said computerized device; and
a location module; said location module being activated by said computerized device; said location module being configured for receiving said location data from said server and for utilizing said location data for activating a navigation application; thereby enabling a user of said web site to navigate to said physical site without inserting the address of said physical site.

2. The navigation system of claim 1, further comprising a data repository, said data repository being configures for storing said location data.

3. The navigation system of claim 1, wherein said geographical site being one member of a group consisting of a hotel, a resort, a restaurant, a pub, a church, a touristic site, a government building, an enterprise and a park.

4. The navigation system of claim 1, wherein the navigation application being a generic navigation application.

5. The navigation system of claim 1, wherein the navigation application being a proprietary navigation application.

6. The navigation system of claim 1, wherein the computerized device being one member of a group consisting of a laptop, a smart phone, a tablet and a personal computer.

7. The navigation system of claim 1 wherein said data repository is farther configured for storing a page of said web site.

8. The navigation system of claim 1; wherein said providing said location data comprises transforming address captured in an image to said location data.

9. The navigation system of claim 1; wherein said providing said location data comprises retrieving said location data from a data repository.

10. A navigation method , said method comprising:
receiving location data of a geographical site; said location data being received as a result of activating a gadget in a web site; said web site being associated with said geographical site; and
utilizing said location data for activating a navigation application; thereby enabling a user of said web site to navigate to said physical site without typing the address of said physical site.

11. The navigation method of claim 10, wherein the navigation application being a generic navigation application.

12. The navigation method of claim 10, wherein the navigation application being a proprietary navigation application.

13. The navigation method of claim 10, wherein said geographical site being one member of a group consisting of a hotel, a resort, a restaurant, a pub, a church, a touristic site, a government building, an enterprise and a park.

14. A computer program placed on a magnetic readable medium, the computer program comprising:
a first program instruction for receiving location data of a geographical site; said location data being received as a result of activating a gadget in a web site; said web site being associated with said geographical site ; and
a second program instruction for utilizing said location data for activating a navigation application; thereby enabling a user of said web site to navigate to said physical site without typing the address of said physical site.
